(19) United States
(12) Patent Application Publication
(10) Pub. No.: US 2013/0149968 A1
(43) Pub. Date: Jun. 13, 2013

(54) Digital Radio Network System

(71) Applicant: Younan Lu, Plano, TX (US)

(72) Inventor: Younan Lu, Plano, TX (US)

(21) Appl. No.: 13/817,561

(22) PCT Filed: Aug. 20, 2011
(86) PCT No.: PCT/US11/48531

§ 371 Date: Feb. 19, 2013

Related U.S. Application Data
(60) Provisional application No. 61/375,842, filed on Aug. 22, 2010.

(51) Int. Cl. H04W 4/00

(52) U.S. Cl. CPC H04W 4/008
USPC 455/41.2

(57) ABSTRACT

The present invention is directed to a system for operating a network of digital radios comprising a digital radio configured with a Bluetooth type protocol. The digital radio further comprises a radio directory, with the radio directory operable to retrievably store radio reception information for a plurality of radios. The radio reception information comprises a unique identifier and Bluetooth address. The digital radio further comprises a radio directory handler, the directory handler configured to selectively retrieve radio reception information from the radio directory for a recipient radio and store the retrieved radio reception information in active memory for communication according to the Bluetooth protocol. The radio directory is preferably populated with radio reception information of a plurality of radios, with the radio reception information for each radio being based on the pairing process between a controller radio and a member radio. The radio directory is then distributed to each member radio, enabling direct communication among all radios in the radio directly. Optionally, the system includes a gateway where the network data can be bridged to external communication systems.

### PRIORITY

The present invention claims priority to provisional application 61/375,842, which has a filing date of Aug. 22, 2010.

### BACKGROUND

1. Field of the Invention

The present invention relates to digital radio frequency communication, more specifically to network enabled digital radios for point to point communication.

2. Description of the Related Art

Teams of individuals in proximity to each other, such as an office or warehouse environment, desire quick and convenient communication with each other. Wireless radio frequency communication, such as two-way or “walkie-talkie” radios have existed in the art for many decades. The walkie-talkie radios are relatively easy to setup and operate for analog communication. However, they suffer some deficiencies in such environments, with some notable deficiencies including privacy of communications, selective one to one communication, and integration with external communication systems.

Walkie-talkie radios allow communication with anyone on the same channel. However, due to law or convention, sometimes office communications must remain private to the caller and recipient. Moreover, as communication increases on a channel, team members sharing that channel hear more irrelevant and distracting communications. The art has sought various approaches to address those issues, including as Continuous Tone Coded Squelch System (“Interference Elimination Codes”) or encryption systems such as APCO-25. Interference Elimination Codes do not provide true privacy, as all radios using a given Interference Elimination Code receive all coded communications. And systems such as APCO-25 are impractical for small area environments. Limited bandwidth, licensing, and cumbersome communications make additional frequency bandwidth impractical.

An additional deficiency of traditional walkie-talkie radios is that they are primarily designed to transport analog audio, thus transport of digital data and integration with external communication systems is limited.

Some digital walkie-talkies have attempted to resolve the issues but fall short. The setup procedures are complex and commonly require technicians to enable the digital walkie-talkie communications. The technicians must plan the communication group and input data into each radio. Typically, the technician must input data such as a unique ID or group ID. If the radio data is not planned properly or input correctly, communication among the radios may not occur or interference may occur in the group.

The advent of the digital radio protocols, such as the Bluetooth protocol, fundamentally address the privacy issue by integrating encryption. Additionally because Bluetooth operates in an unlicensed but managed part of the spectrum, it can be commercially feasible where others needs for RF implementations may not suffice. And the Bluetooth protocol's use of profiles and associated protocol layers enables analog audio and digital data transport. However, the protocol, generally illustrated in FIG. 2, was primarily designed for one to one communication between devices via its “pairing” procedure, where one device acts as the master and the other acts as an accessory. This pairing approach limits the ability for a device to communicate with a plurality of other Bluetooth devices and to selectively communicate with a given device in a network. In order to form a group of Bluetooth radios, each radio must directly pair with each other Bluetooth radio in the group. As the number of Bluetooth radios in the group increases, the number of pairing procedures that must occur increases exponentially. Using that method of forming groups, a given radio will not have a unique identifier at the group level, limiting ability to standardize communication among the group.

The Bluetooth specification discloses a piconet, where a master device can communicate with a theoretical maximum of seven other devices in an ad hoc network. Not many devices support even up to this limit, due to the processing and complexity of the timeslicing method disclosed in operating the network. The Bluetooth specification discloses forming larger networks by joining piconets of Bluetooth devices together to form larger scatternets. However, the problems of the piconet are compounded in the scatternet implementation.

For the above reasons, it would be advantageous to have a system which enables a plurality of digital radios to effectively operate in a readily organized network where each radio can communicate application data directly with any other radio in the network and communicate with external communication systems.

### SUMMARY

The present invention is directed to a system for operating a network of digital radios comprising a digital radio configured with a Bluetooth type protocol. The digital radio further comprises a radio directory, with the radio directory operable to retrievably store radio reception information for a plurality of radios. The radio reception information comprises a unique identifier and Bluetooth address. The digital radio further comprises a radio directory handler, the directory handler configured to selectively retrieve radio reception information from the radio directory for a recipient radio and store the retrieved radio reception information for communication according to the Bluetooth protocol.

These and other features, aspects, and advantages of the invention will become better understood with reference to the following description, and accompanying drawings.

### BRIEF DESCRIPTION OF THE DRAWINGS

FIG. 1 depicts an embodiment of a system of the current invention;

FIG. 2 depicts a common Bluetooth protocol stack for a pair of Bluetooth devices;

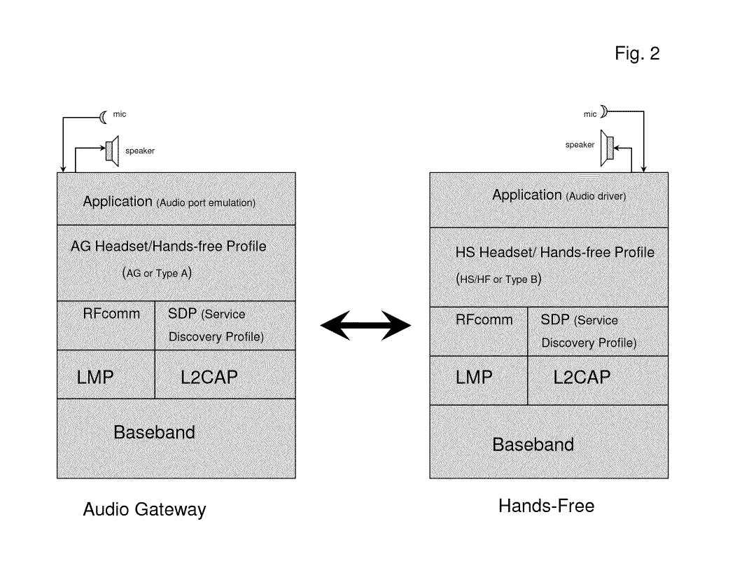

FIG. 3 depicts a modified Bluetooth protocol stack for an embodiment of a controller radio of the current invention;

FIG. 4 depicts a modified Bluetooth protocol stack for an embodiment of a member radio of the current invention;

FIG. 5 depicts a process implemented to the controller radio of FIG. 3;

FIG. 6 depicts a simple pairing sequence between Bluetooth devices according to the Bluetooth specification;

FIG. 7 depicts a process for distributing a radio directory;

FIG. 8 depicts a process of initiating radio to radio communication within the network;

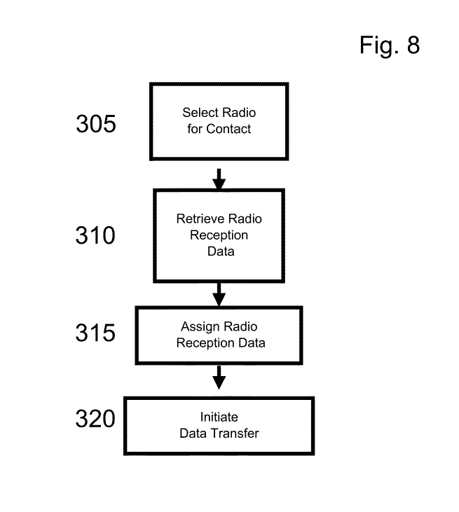

FIG. 9 depicts a Bluetooth protocol stack and flowchart for an alternate embodiment of the current invention;

FIG. 10 depicts a Bluetooth protocol stack and flowchart for the alternative embodiment of FIG. 8.

FIG. 11 depicts a process for generating link keys for the embodiment of FIG. 4; and

FIG. 12 depicts an alternative process generating link keys for the embodiment of FIG. 4.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

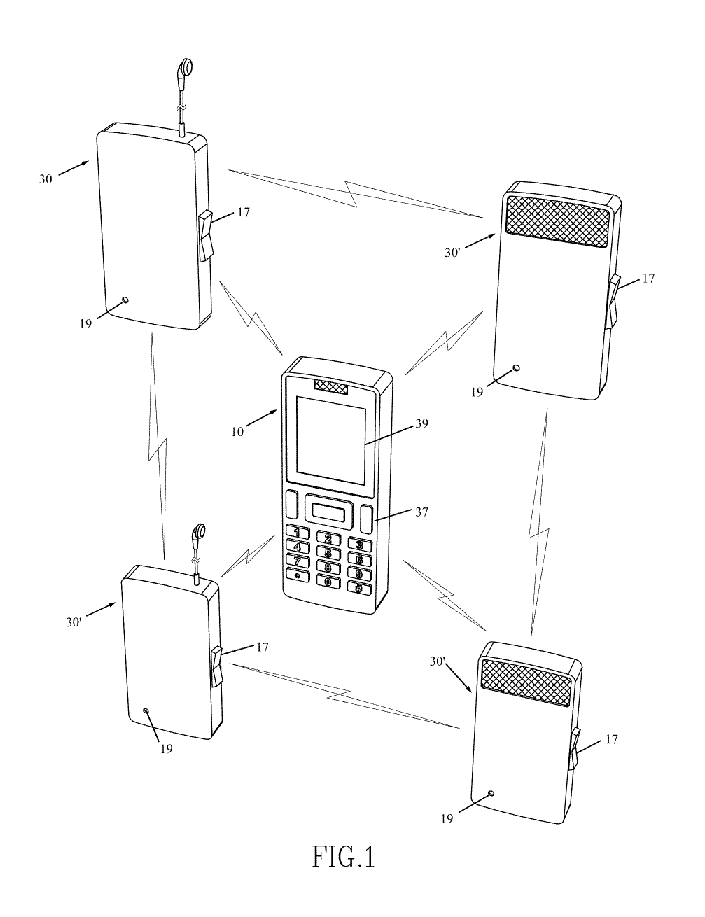

FIG. 1 depicts a plurality of digital radios organized as a network, where each radio within the network can directly communicate with another radio in the network without the need for a central switch or relay. Each radio can transmit voice or other application data to another radio in the network according to a digital communication protocol, such as a Bluetooth type specification. Referring to FIG. 1, which illustrates an embodiment of a controller radio 10 and a plurality of member radios 30 30′. The controller radio 10 includes a controller processor (not pictured), radio memory (not pictured), an input 17, an output (pictured as display 19), a microphone (not pictured), a speaker 20, and a radio frequency (RF) source (not pictured). The member radio includes a member processor (not pictured), a member memory (not pictured), a radio selector 36, a microphone, a speaker 40, and an RF source (not pictured).

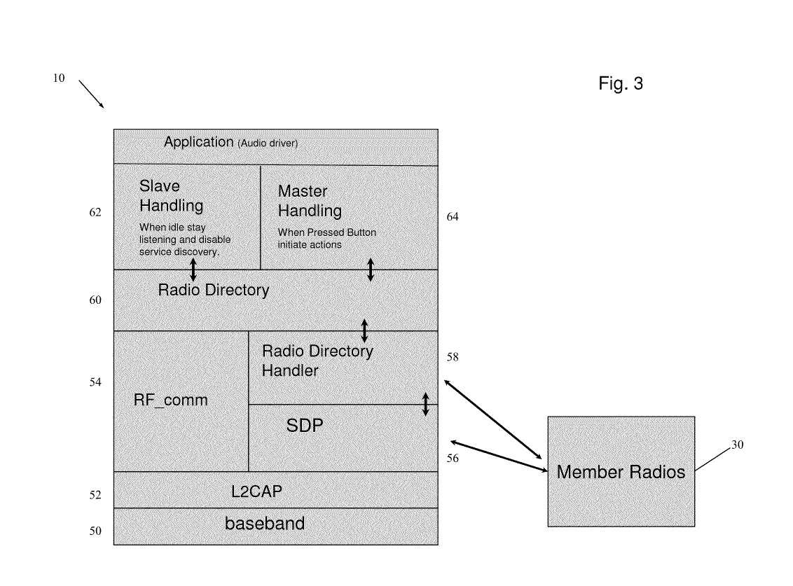

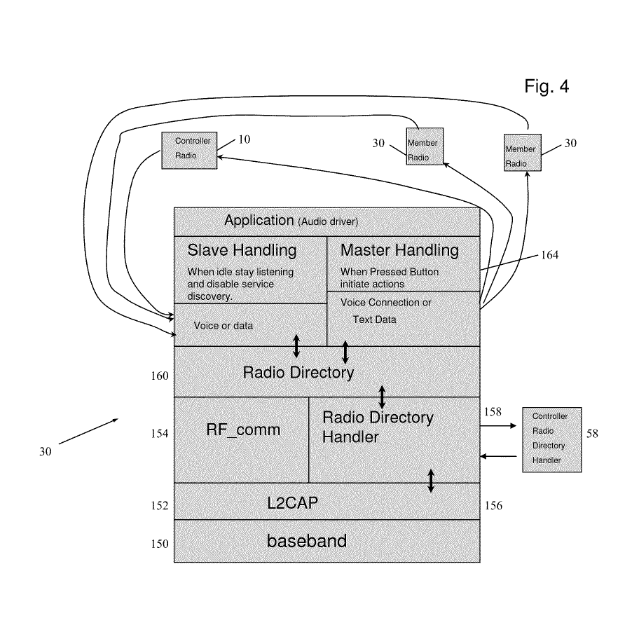

The radios of the current invention can operate under various digital radio communication protocols, with the preferred protocol being a Bluetooth type specification. Although the current embodiment is described in relation to the Bluetooth protocol, it should be appreciated that the current invention can be implemented on a different radio frequency stack of similar specifications. Referring to FIGS. 3 and 4, the protocol stack for the controller radio 10 and member radios 30 of the current embodiment are shown. The controller radio 10 and the member radios 30 are generally configured to operate according to the Bluetooth modification, subject to exceptions noted in this disclosure. Moreover, both the controller radio 10 and the member radios 30 generally operate similarly, with the primary exception being certain aspects of the radio directory handler 58 158.

When the network is in operation, a single radio acts as the controller radio 10. It should be noted that the controller radio 10 and the member radios 30 have a processor, memory, RF source, and the instruction set of both a controller radio 10 and member radio 30. The controller and member radios 10 30 include instructions for polling each others' presence. Should the controller radio 10 fail or otherwise become inaccessible to the network, a member radio 30 can change its mode of operation to that of a controller radio 10 in order to maintain the operation of the network. More specifically, that member radio 30 will reconfigure its stack to that illustrated in FIG. 3.

Referring to FIGS. 3 and 4, the controller radio 10 and the member radio 10 of the current embodiment are configured with a modified version of the Bluetooth stack. The baseband layer 50 150 of the controller radio 10 and member radios is generally implemented as known in the art. Additional disclosure of the baseband layer 50 150 is included in the Bluetooth specification.

The Logical Link Control and Adaptation Layer protocol (L2CAP) 52 152 of the controller radio 10 and member radios is layered over the baseband protocol 50 150 and resides in the data link layer. L2CAP 52 152 provides connection-oriented and connectionless data services to upper layer protocols with protocol multiplexing capability, segmentation and reassembly operation, and group abstractions. L2CAP 52 152 permits higher level protocols and applications to transmit and receive L2CAP 52 152 data packets. The L2CAP layer 52 152 of the current embodiment is generally implemented as known in the art. Additional disclosure of the L2CAP layer 52 152 is included in the Bluetooth specification.

The RFCOMM layer 54 154 of the controller radio 10 and member radios is a set of transport protocols, layered above the L2CAP protocol 52 152 providing emulated serial ports. The L2CAP layer 52 152 of the current embodiment is generally implemented as known in the art. Additional disclosure of the RFCOMM layer 54 154 is included in the Bluetooth specification.

The radio directory layer 60 160 resides in the memory of the controller radio 10 and member radios 30. It contains the radio reception information for each radio in the network and can contain an entry for any number of radios, subject to the memory limits of the radio. The radio directory layer 60 160 enables the controller radio 10 and the member radios 30 to operate as a network, with each radio being able to communicate directly with all other radios in the network without any central switch.

The controller radio 10 manages the radio directory 60 160, which contains entries of the radio reception data for each radio 10 30 in the network. The radio reception information includes information sufficient for any radio 10 30 to communicate with any other radio 10 30, without the pairing process having to occur between member radios 30. Namely, the radio directory 60 160 contains sufficient information to enable any radio in the network to directly transmit and receive application data from any other radio in the network. The radio directory 60 160 includes a unique identifier and information for each radio in the network, such as a unique identifier, Bluetooth addresses, network control data, link keys, and security PINs.

A radio directory entry may also include other radio attributes, such as but not limited to a Bluetooth services or profile of a radio 10 30. Upon instantiation, the radio directory 60 will preferably contain radio reception information for the controller radio 10, although the radio directory 60 160 can be prepopulated with the radio reception information of a plurality of radios.

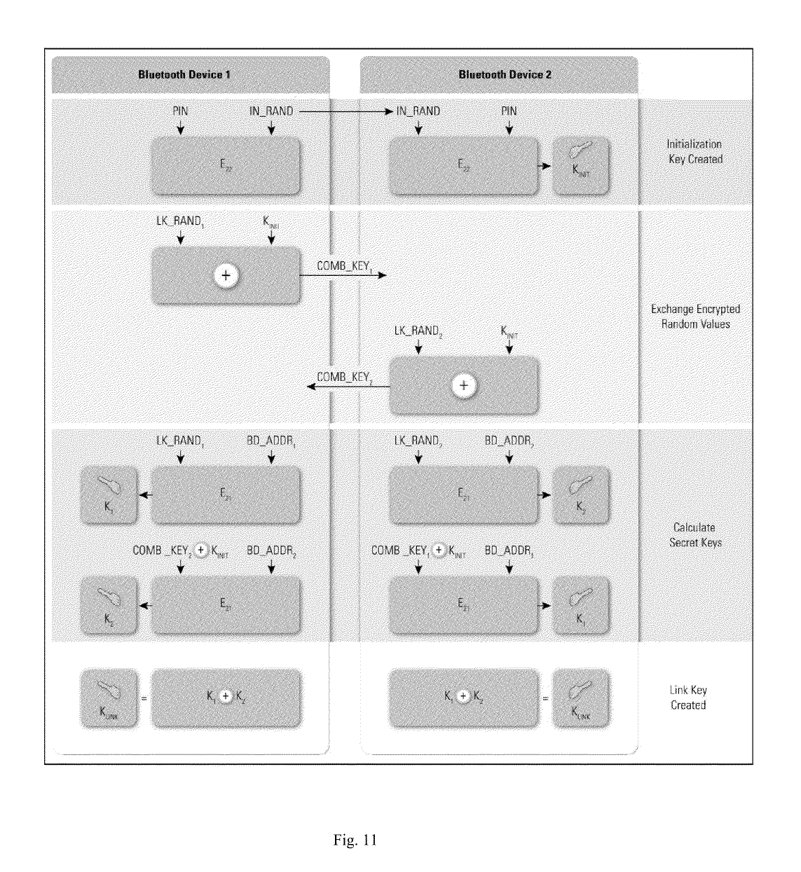

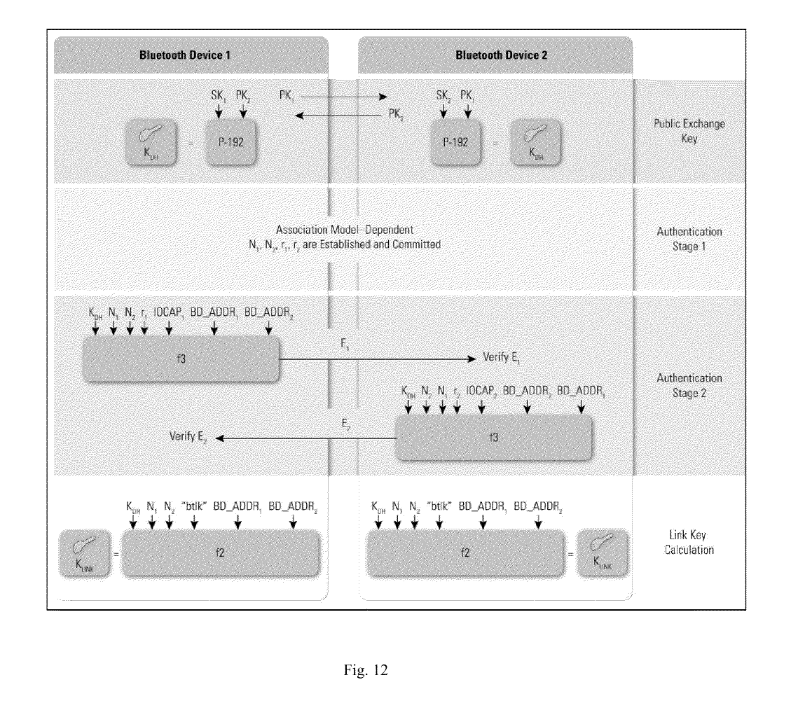

As the link keys and other radio reception information are unique to the radios involved in the pairing sequence, the controller radio 10 may customize the radio directory 60 160 for each member radio 30. For example, an optional link key can be employed in communication under the Bluetooth specification in order to quickly establish a more reliable communication. Because the link key is normally calculated during the pairing sequence, it is not applicable to radios not involved in the subject pairing sequence. Where a link key is preferred for communication within the network, the controller radio 10 will build or calculate link keys for a member radio 30 to enable it to securely communicate to any other network radios and then distribute that customized radio directory 160 to that member radio 30. FIGS. 11 and 12 illustrate two methods for generating link keys under the Bluetooth specification. In other words, the controller radio 30 calculates the link key from the perspective of the subject radio for each of the other radios in the network using the Bluetooth specification for generating link keys. Where the security or other radio reception data is calculated for a subject radio and the remaining radios in the network, a customized radio directory 160 exists for each radio 10 30 in the network.

The radio directory handler layer 58 158 of the controller radio 10 and member radios 30 interacts with the radio directory 60 160 and updates the content as the network is in operation. Common actions include adding a member radio 30 to the network or removing a member radio 30 from the network. For example, when an uninitialized Bluetooth radio is added to the network, the uninitialized radio is paired or registered with the controller radio 10 through the Bluetooth Service Discovery Protocol (SDP) 56. Additional disclosure on the pairing process is in the Bluetooth specification. The radio directory handler 58 158 of the controller radio 10 will add the new member radio's reception information to the radio directory 60 160 subsequent to the pairing.

The radio directory handler 58 of the controller radio 10 may remove radio data when a member radio 30 is removed from the network. Additionally, the radio directory handler 58 of the controller radio 10 may update a radio's data if information other than the link data changes, such as the available services of a radio in the network.

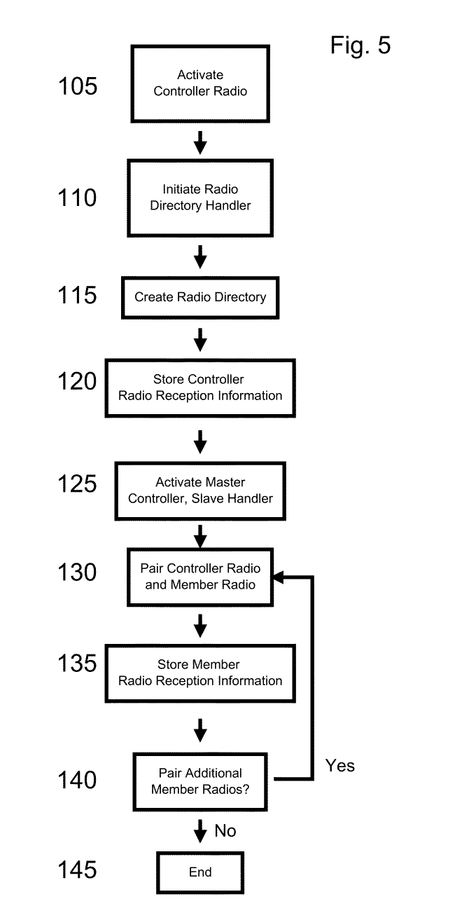

Initially, radios 30 must be added to the network. Once a member radio 30 is added to the network, its radio reception information is added to the radio directory 60, enabling the radio to operate within the network. FIG. 5 depicts a process that can be implemented to the controller radio 10 of the current embodiment for initiating the network. At step 105, the controller radio 10 is activated. The controller radio 30 initiates the radio directory handler 110. The controller radio 10 checks for an existing radio directory 60. If a radio directory 60 for the network does not exist, one is created 115. At step 120, the controller radio 10 stores its own radio reception data in the radio directory 60. The controller radio 10 then initiates the master handling service 64, the member radio handling service 62, and enters a listening state 125.

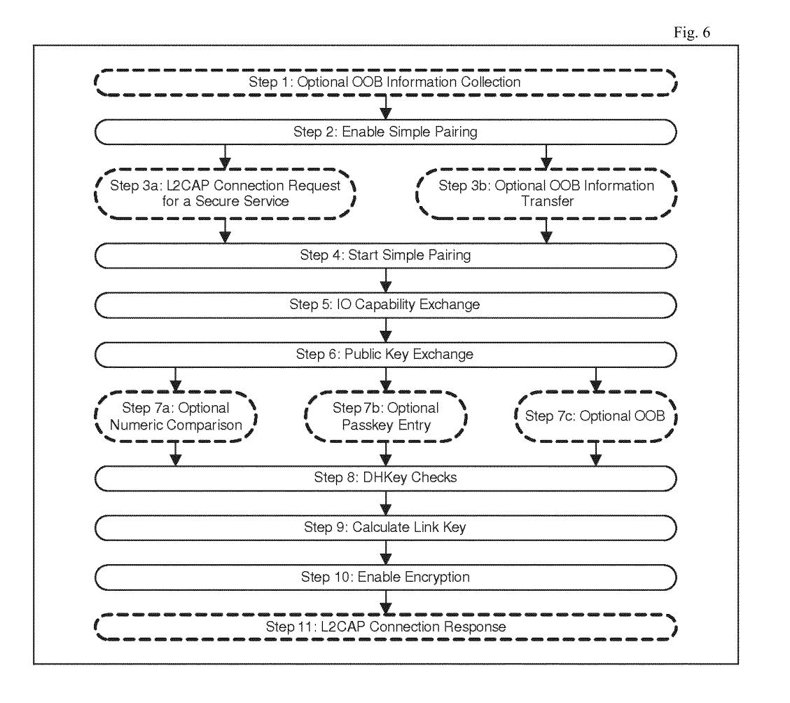

The Bluetooth specification requires that devices which are allowed to connect to be paired in order to communicate with each other. During the pairing process information unique to each radio is used to derive information exchanged between the radio pair. FIG. 6 illustrates a simple pairing sequence between radios according to the Bluetooth specification. It is to be understood that the pairing process of the current invention may deviate from the simple pairing sequence. In order to register the member radio in the radio directory 60, the user of the system initiates the process of pairing the controller radio 10 with the member radio 30. At step 135, the controller radio 10 records stores the base radio reception information for that member radio 30, that is the radio information for the controller radio 10 to communicate with that member radio 30. Additionally, the controller radio can assign a network wide unique identifier to the member radio 30 being added. If there are no additional member radios 30 to be introduced to the network 140, the radios 10 30 enter a listening state.

The radio directory handler 58 of the controller radio 10 distributes an updated radio directory 60 160 to the memory of the member radios 30 through radio directory handler 58 158, enabling the member radios 30 to use the radio reception information entries in the radio directory 60 160 to directly communicate with another radio 10 30 in the directory. The radio directory handler 58 158 can distribute the radio directory 60 160 upon initiation from the member radio 30 or the controller radio 10. Additional trigger events for radio directory 60 160 distribution may include initializing the controller radio 10, initializing a member radio 30, predetermined polling intervals, a communication event by a radio, or other triggers.

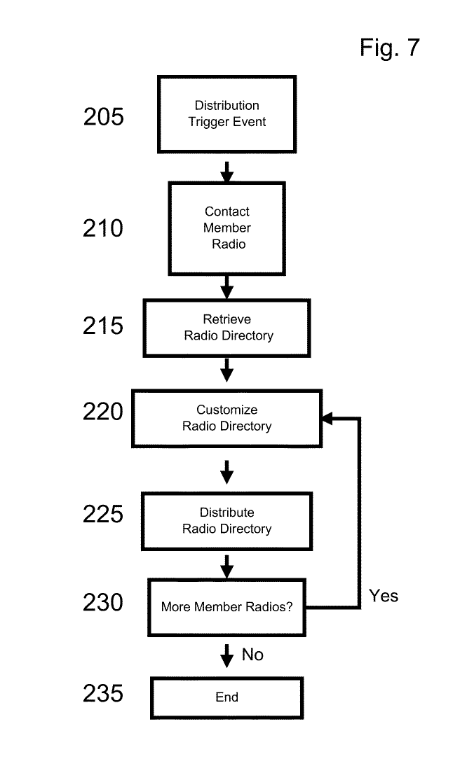

FIG. 7 depicts a process implemented to the system for distributing the radio directory 60 160. First, a trigger event, such as addition of a member radio 30, to the system occurs 205. At step 210, The radio directory handler 58 of the controller radio 10 initiates contact the radio directory handler 158 of the member radio 30. The radio directory 60 is retrieved 215 for preparation for distribution to other member radios 30. Preferably the radio directory 60 is customized for each member radio 30. As mentioned, the information in the radio directory 60 may be base radio reception information, that is pairing information between the controller radio 10 and a given member radio 30. As such, part of that information may only be useful for communication between that radio pair. In order to enable radio 10 30 to radio 30 communication, the base radio reception information in the radio directory 60 is optionally modified and customized for each member radio 220. Base radio reception information may be removed, supplemented, or recalculated to form the distributed radio directory 160. For example, the link key can be removed. Alternatively, the link key may be calculated for the target member radio and the other radios 10 30 within the network. The link key is calculated according to the Bluetooth specification as previously described. Other radio reception information may be removed, supplemented, or calculated prior to distributing a radio directory 160. For example, each radio directory entry can include a network wide unique identifier for each radio 10 30. At step 225, the radio directory 160 is distributed to the target member radio 30. The radio directory handler 58 examines the radio directory 60 and polls for other member radios 30 for distribution of radio directories 160 230. After all member radios 30 receive the updated radio directory 160, the process terminates 235.

The controller radio 10 distributes the radio directory 60 160 to each radio in the network in order to enable each radio to effectively become a switching box for itself, namely to directly call any other network radios 10 30. As stated, any radio in the radio directory 60 160 can communicate with any other radio in the radio directory 60 160. The communication can consist of audio data, such as voice, digital data, such as text, or other application data supported by the Bluetooth protocol. When communication is initiated from a calling radio to a recipient radio, the operator first selects or inputs the desired recipient radio using the input 17 37 305. The calling radio 10 30 retrieves the recipient radio's 10 30 reception information from the radio directory 60 160. The calling radio writes the radio reception information to its active buffer and feeds the radio reception information into its RFCOMM layer for use in communication according to the Bluetooth protocol 315. The recipient radio 10 30 retrieves the calling radio's 10 30 reception information from the radio directory 60 160. The recipient radio writes the radio reception information to its active buffer and feeds the radio reception information into its RFCOMM layer for use in communication according to the Bluetooth protocol 315. The recipient radio's Bluetooth address and preferably the link key is used in preparing the connection in order to establish a higher integrity connection between the radios. A handshake between the calling radio and recipient radio occurs and the radios are ready for communication according to the Bluetooth protocol. The calling radio then request to set up a connections, such as the Synchronous Connections audio connection.

When the calling radio initiates communication to the recipient radio, the preferred method can be non-secured in order to create a faster connection. Optionally, a secure connection may be created by using the retrieved security PIN, link keys, or other radio reception information.

It should be noted that a radio may be operate in multiple configurations simultaneously. Thus, a member radio 30 can simultaneously receive radio directory 160 through directory handler 58 158, listen or receive calls from other radios, and be ready to call any other radio.

To operate this first embodiment of the system in a radio to radio or “walkie-talkie” audio mode, a controller radio 10 and a plurality of member radios 30 are provided and powered on. The network is created by pairing each member radio 30 with the controller radio 10, where the controller radio 30 populates the radio directory 60. The radio directory handlers 58 158 of the controller radio 10 and member radio 30 communicate to update the radio directory 160 in the memory of the member radios 30.

A first operator with a radio 10 30 30′ may depress a radio selector 17 37 to cycle through the available radios in the radio directory 60 160 and select another radio 10 30 30′ with which to communicate. The operator presses the function selector to initiate the connection between the two radios. After the radios establish a connection, the operator then depresses the microphone switch and speaks into the microphone. The radio 10 30 30′ transports the audio via an appropriate audio profile such as the headset profile, hands free profile, or the advanced audio distribution profile. The corresponding member radio's 10 30 30′ speaker 20 40 40′ emits the audio.

Where the operator seeks to send text data, the operator can may depress a radio selector 17 37 to cycle through the available radios 10 30 in the radio directory 60 160 and select another radio 10 30 30′ with which to communicate. The operator may use an alphanumeric input to compose a message. The radio 10 30 30′ transports the digital data via an appropriate application profile and the message is displayed on the display of the prescribed member radio 10 30 30′.

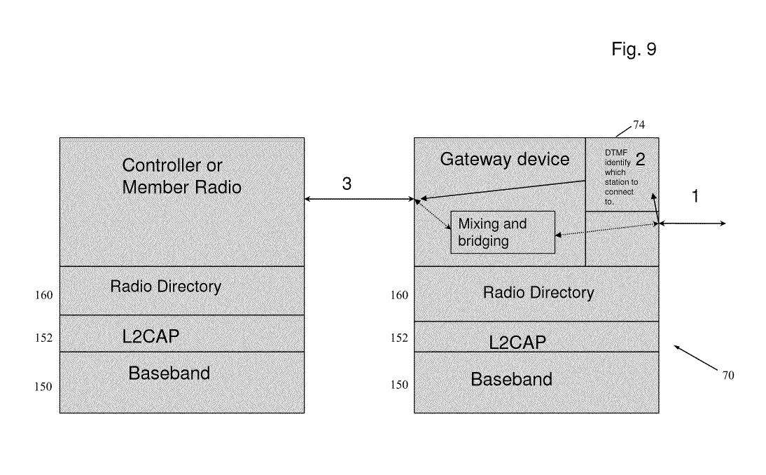

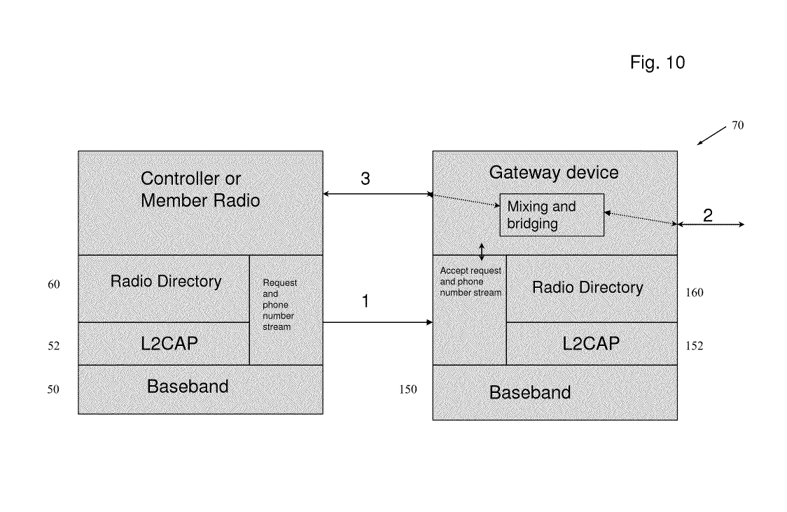

FIGS. 9 and 10 depict an alternate embodiment of the digital radio network system wherein the radios 10 30 of the Bluetooth network can transceive application data with external systems. In the depicted embodiment, the network is operable to communicate with a telephone system, enabling radios within the network to initiate and receive phone calls. The system includes the controller radio 10 and member radio of 30 of the first embodiment. The controller radio 10 and member radios 30 further comprise a numeric input to enter a telephone number.

This embodiment further comprises a gateway 70. The gateway 70 couples the digital radio network with the plain old telephone system (POTS). The gateway 70 can be integrated with either a controller radio 10 or a member radio 30, but as illustrated is integrated with a member radio 30. With the gateway 70 having both a POTS connection and being a member of the digital radio network, audio can be relayed between radios 10 30 and the telephone system.

FIG. 9 illustrates the operation of this embodiment in initiating a telephone call from a member radio 30. The operator inputs a telephone number into the interface presented by the member radio 30. The input is transmitted to the gateway 70 which creates the telephone connection. Upon a successful telephone connection, audio from the microphone of the member radio 30 is transmitted across the from the member radio 30 network to the gateway using an appropriate audio profile. The gateway 70 then relays the audio to the telephone system. Audio from the POTS side of the telephone conversation is relayed from the POTS to the member radio 30 and emitted from the speaker.

FIG. 10 illustrates the operation of this embodiment in receiving a telephone call to a member radio 30. The radio directory 60 160 of the networked radios 10 30 30′ contains additional information based on the identifier for each radio. A user perceptible identifier, such as the name of the radio operator, is correlated with radio information. Additionally, a phone number is associated with the gateway 70. When a caller seeks to contact a member within the digital radio network, he or she initiates a phone call to the phone number associated with the gateway 70. The gateway 70 receives and answers the phone call and presents an audio interface to the caller. The caller can input information which the gateway 70, in turn, correlates to a radio in the network. For example, the caller may speak the name of a radio operator. Alternatively, the caller may use dual tone multi-frequency (DTMF) to enter a number associated with a given radio operator. The gateway 70 creates an audio channel between the caller and radio operator. The gateway 70 relays the audio from the caller to the operator's radio 30. The gateway 70 also relays the audio from the networked radio to the caller.

Insofar as the description above and the accompanying drawings disclose any additional subject matter that is not within the scope of claims, the inventions are not dedicated to the public and the right to file one or more applications to claim such additional inventions is reserved.

What is claimed is:

1. A system for operating a network of digital radios comprising:
a digital radio configured with a Bluetooth type protocol;
said digital radio further comprising a radio directory, said radio directory operable to retrievably store radio reception information for a plurality of radios;
said radio reception information comprising a unique identifier and Bluetooth address; and
said digital radio further comprising a radio directory handler, said directory handler configured to selectively retrieve radio reception information from said radio directory for a recipient radio and store said retrieved radio reception information for communication according to the Bluetooth protocol.

2. The system of claim 1 wherein said radio reception information further comprises a link key and a PIN.

3. The system of claim 1 wherein said radio directory handler is further configured to retrievably store radio reception information from the pairing process between said digital radio and a plurality of additional digital radios in said radio directory.

4. The system of claim 3 wherein said radio directory handler generates a network wide unique identifier for inclusion in the radio reception information for each digital radio in said radio directory.

5. The system of claim 3 wherein said radio directory handler is further configured to populate a second radio directory with radio reception information generated from the radio reception information from the pairing process between said digital radio and a second digital radio, said second radio directory comprising radio reception information based on said pairing process and a third digital radio, said second radio directory enabling said third digital radio to communicate with said digital radio or said second digital radio.

6. The system of claim 5 wherein said generated radio reception information comprises a link key.

7. The system of claim 1 wherein said directory handler is further configured to distribute said radio directory.

8. The system of claim 1 further comprising a gateway, said gateway in communication with an external communication network and relaying data between said external communication network and said digital radio.

9. A network of digital radios comprising:
a controller radio configured with a Bluetooth type protocol;
said controller radio further comprising a radio directory, said radio directory operable to retrievably store radio reception information for a plurality of radios;
said radio reception information comprising a unique identifier and Bluetooth address;
said controller radio further comprising a radio directory handler, said directory handler configured to selectively retrieve radio reception information from said radio directory for a recipient radio and store said retrieved radio reception information in active memory for communication according to the Bluetooth protocol;
at least one member radio configured with a Bluetooth type protocol;
said member radio further comprising a radio directory, said radio directory operable to retrievably store radio reception information for a plurality of radios; and
said member radio further comprising a radio directory handler.

10. The system of claim 9 wherein said radio reception information further comprises a link key and a PIN.

11. The system of claim 9 wherein said radio directory handler of said controller radio is further configured to retrievably store radio reception information from the pairing process between said controller radio and a plurality of member radios in said radio directory.

12. The system of claim 11 wherein said radio directory handler generates a network wide unique identifier for inclusion in the radio reception information for each Bluetooth type radio in said radio directory

13. The system of claim 11 further comprising a second member radio, wherein said radio directory handler of said controller radio is further configured to populate a unique radio directory with radio reception information generated from the radio reception information from the pairing process between said controller radio and said first member radio, said unique directory enabling said second member radio to communicate with said first member radio using said generated radio reception information.

14. The system of claim 13 wherein said generated radio reception information comprises a link key.

15. The system of claim 11 wherein said radio directory handler of said controller radio is further configured to store the radio reception information based on each pairing process between said controller radio and additional member radios in said radio directory, said radio directory enabling communication between all radios contained therein.

16. The system of claim 11 further comprising an additional member radio, wherein said radio directory handler of said controller radio is further configured to create a unique radio directory with radio reception information generated from the radio reception information from the pairing process between said controller radio and said first member radio, said unique directory enabling said additional member radio to communicate with said controller radio and said first member radio using said generated radio reception information.

17. The system of claim 16 wherein said generated radio reception information comprises a link key.

18. The system of claim 9 wherein said directory handler is further configured to distribute said radio directory.

19. The system of claim 9 wherein said directory handler is further configured to distribute said radio directory upon a trigger event.

20. The system of claim 9 further comprising a gateway, said gateway in communication with an external communication network and relaying data between said external communication network and said controller radio.

21. The system of claim 20 wherein said external communication network comprises a telephone system.

22. The system of claim 9 wherein said member radio is configured to operate as a controller radio mode upon inaccessibility of said controller radio.

23. A method for forming a network of digital radios comprising:
(a) providing a controller radio configured with a radio directory and radio directory handler;
(b) pairing at least one member radio with said controller radio;
(c) said directory handler storing radio reception information for said controller radio in said radio directory;
(d) said directory handler storing radio reception information for said member radio in said radio directory;
(d) said controller radio storing reception information of said member radio in said radio directory; and
(e) said controller radio distributing said radio directory to said member radio.

24. The method of claim 23, step (c) further comprising the directory handler generating a network wide unique identifier for said controller radio.

25. The method of claim 23, step (d) further comprising the directory handler generating a network wide unique identifier for said member radio.

26. The method of claim 23, further comprising:
(f) pairing a second member radio with said controller radio;
(g) said radio directory handler populating a second radio directory with radio reception information generated from the radio reception information from the pairing process between said controller radio and first member digital radio, said second directory enabling said second member radio to communicate with said first member radio and said controller radio using said generated radio reception information.
(e) said controller radio distributing said radio directory to said second member radio.
